(19) United States
(12) Patent Application Publication
(10) Pub. No.: US 2020/0221670 A1
(43) Pub. Date: Jul. 16, 2020

(54) Diaper for Pets

(71) Applicant: Yong WANG, Shanghai (CN)

(72) Inventor: Yong WANG, Shanghai (CN)

(21) Appl. No.: 16/248,536

(22) Filed: Jan. 15, 2019

(51) Int. Cl. A01K 23/00

(52) U.S. Cl. CPC A01K 23/00

(57) ABSTRACT

Present invention teaches a diaper for pets where a pocket for putting additional absorption materials helps to increase the absorbing capacity of the diaper, on top of the liner layer; use of the Velcro strips enhances the ease of handling of the diaper. A peelable identification patch allows for easy inscription of the pet's name or other contact, either by writing on the removable part of the patch, or printing or other means. An alternative implementation allows the patch to be located on the back of the pet, instead of at the under belly position.

### FIELD AND BACKGROUND OF THE INVENTION

Present invention disclosed a pet diaper where the liner material is made with good absorption and aeration capabilities. In addition, a pocket is made to allow enhanced absorption capacity when suitable materials, such a tissue paper, cotton, small towels, etc. can be inserted into the pocket to provide better absorption when the diaper has to be in use for longer period of time before the owner has to change, reducing the hassle of frequent diaper changing, while adding to the comfort level of the pets wearing the diaper of present invention.

### SUMMARY OF THE INVENTION

The invention relates to a pet diaper, particularly the pet diaper of present invention allows for more flexibility of use for large or small pets, such as dogs, given the size-adaptability and the enhanced absorptive capacity.

The diaper is made primarily by a piece of fabric with an elongated shape having two extending bands. A first side will be the inside surface of the diaper when wrapped around the body of a pet; a second will be the outside surface of the diaper when in use.

Velcros are used at the distal ends of the two extending bands, providing the easy attachment function to applying the diaper to a pet.

A hole with stretchable edges is located in the middle portion the fabric. The hole is for the purpose of allowing the tail of a pet to be sticking out when the diaper is in use.

The inside surface of the diaper contains a liner 88 made with materials to achieve the attributes of high aeration and liquid-absorbing. An embodiment of the liner 88 contains 100% polyester material.

To accommodate heavier days, or when a pet owner knows the diaper needs to sustain the use for a longer period of time between changing, a pocket is made between the hole and the front portion of the fabric for inserting suitable wet-absorbing materials. Any suitable wet-absorbing materials, such as tissue paper, baby wipes, cotton, or something similar to women's panty-liner, can be used to enhance the absorption capacity of the diaper on top of the liner. No additional limitation or disclosure is needed to the use of the suitable wet-absorbing materials; users can use any off-the-shelf products as the inserts for putting into the pocket.

The edges in the middle portion of the fabric are made with enhanced stretching elasticity, providing additional size-adaptability for using on pets of varying sizes.

In another optional embodiment, the second side of the fabric has an extra water-proofing layer made from the materials of flexible plastic materials such as PE or soft nylon. The extra water-proofing layer further adds to the utility of the diaper by reducing the chance of potential leaks. No additional limitation or disclosure is needed related to the extra water-proofing layer, as this component can be obtained from any off-the-shelf products as long as the purpose of water-proofing is achieved.

Attaching the extra water-proofing layer requires no additional disclosure, as it would be similar to the way when the liner 88 is attached to the first side AA. There are various known art approaches to the implementation of the adding an extra layer to the second side BB that renders the disclosure herein unnecessary.

A peelable identification patch is located at on the front end of the second side, allowing identification information to be easily attached to or removed from said fabric.

Alternatively, the peelable identification patch 50** can be made to be located on the front end of the first side, allowing the identification information to be seen from a normal top-down view. The construction of the peelable identification patch, including the alternative construction, can use the common Velcro strips, or other known art in the industry that requires no disclosure herein.

### DESCRIPTION OF THE DRAWINGS

The accompanying drawings, which are incorporated in and constitute a part of this specification, illustrate and exemplify the preferred embodiments of the invention. Together with the description, serve to explain the principles of the invention.

A brief description of the drawings is as follows:

FIG. 1 shows the outside surface, the second side BB, of the diaper of present invention.

FIG. 2 shows the inside surface, the first side AA, of the diaper of present invention.

FIG. 3 shows the diaper in use when viewing from top-down to the back side of a pet.

FIG. 4 shows the diaper in use when viewing from the under belly of a pet.

### DETAILED DESCRIPTION OF THE PREFERRED EMBODIMENT

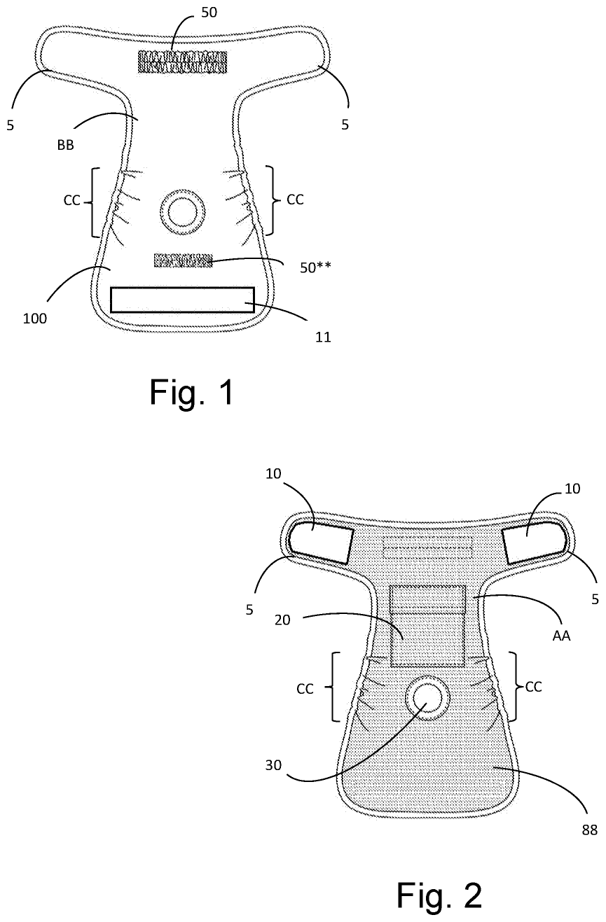

A Diaper for pets is made of a piece of fabric 100 having a first side AA and a second side BB. The fabric is made generally in an elongated shape with two extending bands 5 in the front portion, as shown in FIGS. 1 and 2.

The first side AA will be the inside surface of the diaper when wrapped around the body of a pet, as shown in FIG. 2.

The second side BB will be the outside surface of the diaper when in use, as shown in FIG. 1.

The fabric 100 is made from any suitable and stretchable materials, so that some flexibility is achieved, given a certain size of the diaper, when wrapping the lower body of a pet, such as a dog. Two extending bands 5 are formed in the front portion of said fabric 100 with Velcro strips 10 attached to the first side AA of said fabric 100 located at the distal ends of the two bands 5.

The first side AA contains a liner 88 made with materials to achieve the attributes of high aeration and liquid-absorbing.

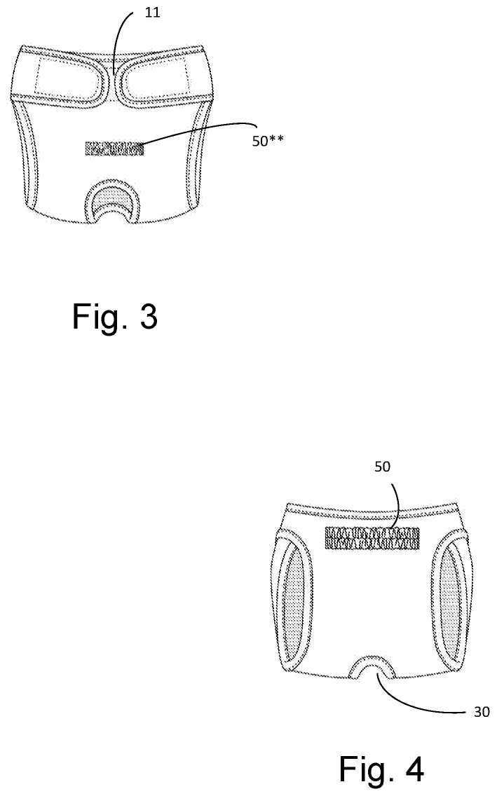

Another Velcro strip 11 is attached to the back portion of said fabric 100 on the second side BB. As such, when the diaper of present invention is in use, the two Velcro strips 10 will be wrapped around the mid-section of a pet and meshed together with the Velcro strip 11, as depicted in FIG. 3, which shows a top-down view looking at the back of a pet.

FIG. 4 shows the view when looked up from the under belly of a pet wearing the diaper of present invention.

A hole 30 with stretchable edges CC is located in the middle portion the fabric 100. The hole 30 is for the purpose of allowing the tail of a pet to be sticking out when the diaper is in use.

A pocket 20 is formed between said hole 30 and the front portion of the fabric 100 for inserting suitable wet-absorbing materials. Any suitable wet-absorbing materials, such as tissue paper, baby wipes, cotton, or something similar to women's panty-liner, can be used to enhance the absorption capacity of the diaper on top of the liner 88.

In a specific embodiment, the fabric materials for the surfaces of sides AA and/or BB uses a certain jersey material that contains the three main ingredients of cotton, polyester and Lycra where the composition ratio of the three ingredients is substantially in the range of 30-35% (Cotton), 60-65% (polyester) and 2-10% (Lycra).

The edges CC in the middle portion of the fabric are made with enhanced stretching elasticity, providing additional size-adaptability for using on pets of varying sizes.

In another embodiment, the second side BB of the fabric 100 has an extra water-proofing layer made from the materials of flexible plastic materials such as PE or soft nylon. The extra water-proofing layer further adds to the utility of the diaper by reducing the chance of potential leaks.

A peelable identification patch 50 is located at on the front end of the second side BB, allowing identification information to be easily attached to or removed from said fabric 100. Said identification patch 50 can be seen from the under belly view, as shown in FIG. 4.

The construction of the peelable identification patch 50 can also rely on the use of a Velcro where a base strip is made on the fabric 100 with a removable patch 50, containing corresponding Velcro strip, for inscribing pets' names by writing, printing, sewing, or any regularly known means.

Alternatively, the peelable identification patch 50** can be made to be located on the front end of the first side, allowing the identification information to be seen from a normal top-down view. In this alternative implementation, the identification patch 50** will be in a offset position receding from the back portion of the fabric 100, between Velcro strip 11 and the hole 30, so as not to be covered by the two extending bands 5 when in use, as shown in FIG. 3.

1. Diaper for pets, comprising:
A piece of fabric for stretchably wrapping the lower body of a pet, said fabric having a first side and a second side, wherein the first side contains a liner made with materials to achieve the attributes of high aeration and liquid-absorbing;
Two extending bands are formed in the front portion of said fabric with Velcro strips attached to the first side of said fabric located at the distal ends of the two bands;
A Velcro strip is attached to the back portion of said fabric on the second side;
A hole with stretchable edge is located in the middle portion the fabric; and
A pocket is formed between said hole and the front for inserting suitable wet-absorbing materials, whereby the fabric can be wrapped around the lower body of a pet, with the two bands' Velcro strips meshed together with the Velcro strip at the back portion of said fabric.

2. The diaper for pets in claim 1 where the liner of the first side contains 100% polyester material.

3. The diaper for pets in claim 1 wherein the material for the first and/or second side surfaces contains three main ingredients of cotton, polyester and Lycra having composition ratio substantially in the range of 30-35% (Cotton), 60-65% (polyester) and 2-10% (Lycra).

4. The diaper for pets in claim 1 wherein the edges in the middle portion of the fabric are made with enhanced stretching elasticity.

5. The diaper for pets in claim 1 wherein a peelable identification patch is located at on the front end of the second side, allowing identification information to be easily attached to or removed from said fabric.

6. The diaper for pets in claim 5 wherein the peelable identification patch is alternatively located on the front end of the first side, allowing the identification information to be seen from a normal top-down view.
